(19) United States
(12) Patent Application Publication
(10) Pub. No.: US 2026/0227254 A1
(43) Pub. Date: Aug. 6, 2026

(54) DEFORMABLE SENSING ASSEMBLY HAVING 3D MARKERS

(71) Applicant: Toyota Research Institute, Inc., Los Altos, CA (US)

(72) Inventors: Edwardo Martinez, Fremont, CA (US); Haeyeon Lee, Los Altos, CA (US); Jonathan Yao, San Jose, CA (US)

(73) Assignees: Toyota Research Institute, Inc., Los Altos, CA (US); Toyota Jidosha Kabushiki Kaisha, Toyota-shi (JP)

(21) Appl. No.: 19/045,687

(22) Filed: Feb. 5, 2025

(51) Int. Cl. G01L 1/24

(52) U.S. Cl. CPC G01L 1/247

(57) ABSTRACT

In one embodiment, a deformable sensing assembly includes a deformable layer, having one or more 3D markers movable in response to an external force applied thereto, wherein the one or more 3D markers are positioned in a region of the deformable layer defining an impacted region, and an image sensor to capture an image representative of the impacted region. A force profile of the external force applied to the impacted region is determined using a displacement of the one or more 3D markers in response to the applied external force.

### TECHNICAL FIELD

Embodiments described herein generally relate to contact sensors and, more particularly, to deformable contact sensors capable of detecting contact from an external source. Embodiments also relate to methods for determining a force profile of externally-applied contact including a position and/or strength of the applied contact.

### SUMMARY

In one embodiment, a deformable sensing assembly includes a hollow vessel comprising a first side and a second side, wherein the first side is positioned opposite the second side, a deformable layer coupled to at least a portion of the hollow vessel, the deformable layer including one or more 3D markers suspended in the deformable layer, wherein the one or more 3D markers are movable in response to an external force applied thereto, an image sensor positioned on the first side of the hollow vessel, and a mirror positioned on the second side of the hollow vessel. A portion of the deformable layer positioned between the image sensor and the mirror defines an impacted region to which the external force is applied, and wherein the image sensor captures an image representative of the impacted region reflected to the image sensor by the mirror. A force profile of the external force applied to the impacted region is deduced using the image captured by the image sensor.

In another embodiment, a deformable sensing assembly includes a deformable layer, having one or more 3D markers movable in response to an external force applied thereto, wherein the one or more 3D markers are positioned in a region of the deformable layer defining an impacted region, and an image sensor to capture an image representative of the impacted region. A force profile of the external force applied to the impacted region is determined using a displacement of the one or more 3D markers in response to the applied external force.

In another embodiment, a method for monitoring an external force applied to an object using a deformable sensing assembly includes capturing, by an image sensor, a baseline image of a deformable sensing assembly coupled to an object, wherein the deformable sensing assembly includes one or more 3D markers movable in response to an external force applied thereto, capturing, by an image sensor, a second image of the deformable sensing assembly upon application of an external force thereto, comparing, by a processor, an orientation of the one or more 3D markers in the baseline image to an orientation of the one or more 3D markers in the second image, deducing, by the processor, a location of the applied external force along an impacted region based at least in part on the comparison of the orientation of the one or more 3D markers between the baseline image and the second image, and deducing, by the processor, a force profile of the applied external force along the impacted region based at least in part on the comparison of the orientation of the one or more 3D markers between the baseline image and the second image.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a deformable sensing assembly according to one or more embodiments described and illustrated herein;

FIG. 2 depicts a deformable sensing assembly coupled to an object according to one or more embodiments described and illustrated herein;

FIG. 3 depicts a deformable sensing assembly having a 3D mesh structure according to one or more embodiments described and illustrated herein;

FIG. 4A depicts a piece of athletic equipment for monitoring using a deformable sensing assembly according to one or more embodiments described and illustrated herein; and

FIG. 4B depicts a piece of industrial equipment for monitoring using a deformable sensing assembly according to one or more embodiments described and illustrated herein.

### DETAILED DESCRIPTION

Various fields exist where a user must grasp and manipulate an object with precision to achieve an optimal, desired result. Exemplary fields include golfing, welding, playing tennis, and the like. For example, in golf the manner in which, including how and where, the user grasps a golf club significantly affects how a target golf ball is hit and travels. As such, a need exists for a deformable sensing assembly to provide feedback to a user as to where and how a user should grasp an object to yield optimal, desirable results.

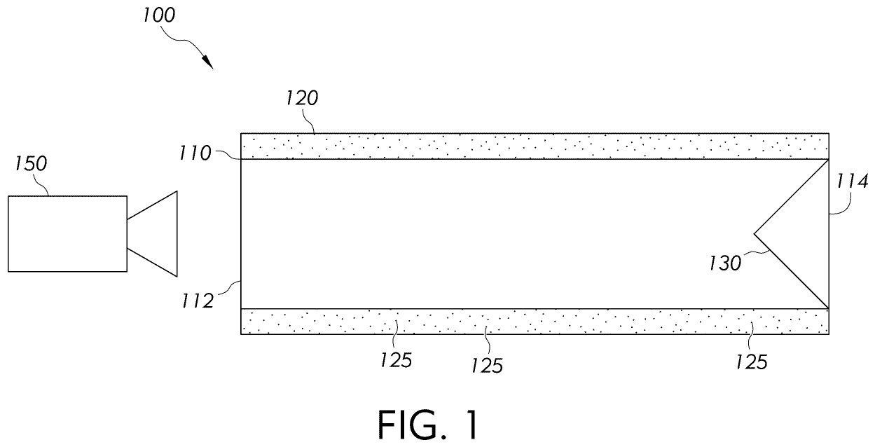

Turning to FIG. 1, a deformable sensing assembly 100 is depicted. The deformable sensing assembly 100 includes a hollow vessel 110 and one or more deformable layers 120 disposed, or otherwise formed, over at least a length thereof. The deformable layer 120 includes one or more 3D markers 125 dispersed throughout the deformable layer 120. In various instances, multiple deformable layers 120 can be stacked, or otherwise formed, on top of one another. The hollow vessel 110 includes a first end 112 and a second end 114, the second end 114 extending opposite the first end 112. An image sensor 150 is positioned adjacent the first end 112 of the hollow vessel 110, and a mirror 130, such as a conical mirror or the like, is positioned adjacent the second end 114 of the hollow vessel 110. The mirror 130 is shaped to provide the image sensor 150 with a field of view of the one or more deformable layers 120 along a length of the deformable sensing assembly 100.

The hollow vessel 110 can be slid over, or otherwise coupled to, a particular object to monitor user interaction therewith. In various instances, the hollow vessel 110 is a tube, such as a cylindrical tube. However, the hollow vessel 110 may be sized and/or shaped in any suitable manner to closely surround at least a portion of the object to be monitored. In such instances, the hollow vessel 110 closely surrounds the portion of the object with which a user interacts, hereinafter referred to as the impacted region. In various instances, the first end 112 of the hollow vessel 110 can be slid onto a shaft of an object, for example. However, the hollow vessel 110 can be coupled to the object in any suitable manner, such as by being molded overtop of the object and/or through the use of adhesives, for example.

The image sensor 150 is positioned relative to the hollow vessel 110 such that the image sensor 150 has an unobstructed view of the mirror 130. As such, the image sensor 150 is able to capture a reflected image from the mirror 130. Stated another way, while the mirror 130 is shown as being positioned adjacent the second end 114 of the hollow vessel 110 and the image sensor 150 is shown as being positioned adjacent the first end 112 of the hollow vessel 110, the mirror 130 and the image sensor 150 can be selectively positioned any suitable distance apart from one another such that the image sensor 150 can suitably capture a reflection of the impacted region.

As discussed above, one or more 3D markers 125 are dispersed throughout the deformable layer 120. The one or more 3D markers 125 can include a bead, a flake of glitter, a ball, a gelatinous substance, and/or any suitable object and/or material having three dimensions. In various instances, the one or more 3D markers 125 are suspended in a medium within the deformable layer 120 such that the one or more 3D markers 125 are movable in response to an external force applied thereto, such as by a user, for example. However, in instances where the one or more 3D markers 125 is independently flowable, such as a gelatinous substance, the suspension medium may or may not be used. In various instances, the medium includes a fluid, such as water, a gelatinous substance, and/or any suitable medium that permits movement of the one or more 3D markers 125 suspended therein. In various instances, the one or more 3D markers 125 are rigid in nature. In other instances, the one or more 3D markers 125 are flexible, so that any displacement and/or disfigurement within an individual 3D marker 125 can also be tracked, monitored, and/or otherwise analyzed.

The one or more 3D markers 125 can be dispersed uniformly throughout the deformable layer 120. As such, in a natural, relaxed state where no external forces are being applied to the deformable layer 120, the one or more 3D markers 125 can be spaced equidistantly from one another throughout at least an impacted region of the deformable layer 120. In various instances, the one or more 3D markers 125 can be more heavily concentrated in a particular portion of the impacted region. An increased concentration of 3D markers 125 can result in a finer and/or more precise analysis of the external forces exerted on the impacted region.

In various instances, the one or more 3D markers 125 include three-dimensional objects of different colors. Such variation in color can assist a processor and/or a user in identifying movement and/or displacement of a particular 3D marker 125 relative to surrounding 3D markers 125, for example. In other instances, the one or more 3D markers 125 are the same color as each other.

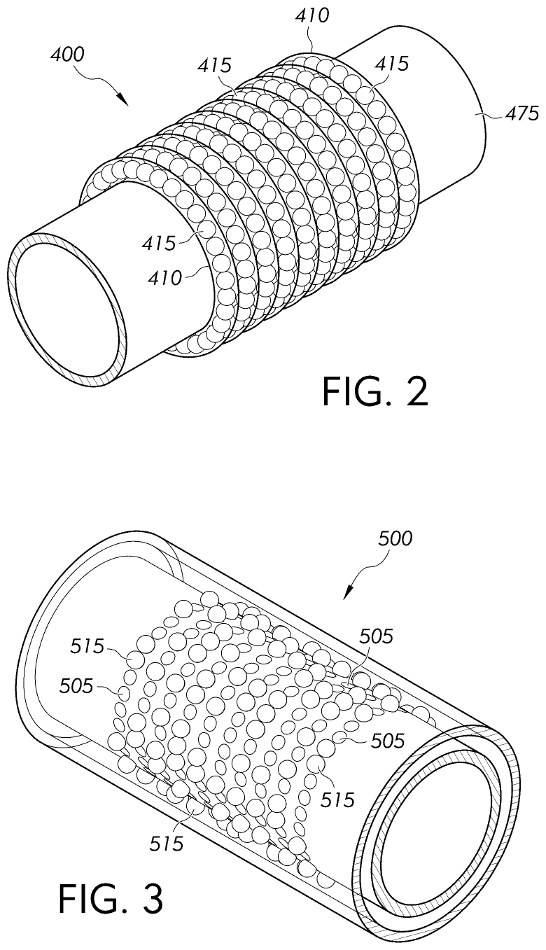

Referring now to FIG. 2, a deformable sensing assembly 400 is depicted coupled to an object 475. The deformable sensing assembly 400 includes a deformable tube 410 including one or more 3D markers 415 dispersed therethrough. The deformable tube 410, including the one or more 3D markers 415 dispersed therethrough, is similar in many respects to the deformable layer 120 of the deformable sensing assembly 100. As such, for the purpose of brevity, the particular details of similar features will not be repeated herein. Notably, instead of being formed over top of a hollow vessel, such as the hollow vessel 110, the deformable tube 410 can be wrapped around, or otherwise coupled to the impacted region of the object 475. Stated another way, the deformable tube 410 can be coupled directly to the impacted region of the object 475, for example.

As with the deformable sensing assembly 100, the deformable sensing assembly 400 includes one or more 3D markers 415 suspended within a medium along at least a portion of the deformable sensing assembly 400. As an external force is applied to the deformable sensing assembly 400 by a user, the deformable tube 410 deforms, which thereby displaces adjacent 3D markers 415, for example. An image sensor, such as a camera, of the deformable sensing assembly 400 can capture images of the deformable tube 410 and/or the one or more 3D markers 415 in their displaced state for use in analyzing and/or deducing a force profile including a strength and/or placement of the user's contact.

FIG. 3 depicts a deformable sensing assembly 500 including a body 505 having a 3D mesh structure. The body 505 is similar in many respects to the hollow vessel 110 and the deformable layer 120 of the deformable sensing assembly 100. The body 505 includes a plurality of faces, edges, and vertices that define a mesh, or lattice-like structure. Instead of a suspension medium as in the deformable sensing assembly 100, the body 505 supports one or more 3D markers 515 thereon. The one or more 3D markers 515 are similar in many respects to the one or more 3D markers 115. As such, for the purpose of brevity, the particular details of similar features will not be repeated herein. The one or more 3D markers 515 can be coupled, or otherwise secured, to the body 505 in any suitable manner. In various instances, the one or more 3D markers 515 can be press-fit between edges of the body 505 and/or an adhesive can be used.

Similar to the hollow vessel 110, the mesh structure is sized and/or shaped to be closely received adjacent an object to be monitored, for example. In various instances, the body 505 is rigid in nature. As such, when an external force is applied to the deformable sensing tube 410, only the one or more 3D markers 515 move. In other instances, the body 505 is flexible, or pliable, in nature. In such instances, when an external force is applied to the deformable sensing tube 410, movement of both the one or more 3D markers 515 and the body 505 can be monitored by an image sensor to deduce a force profile including a strength and/or placement of a user's contact.

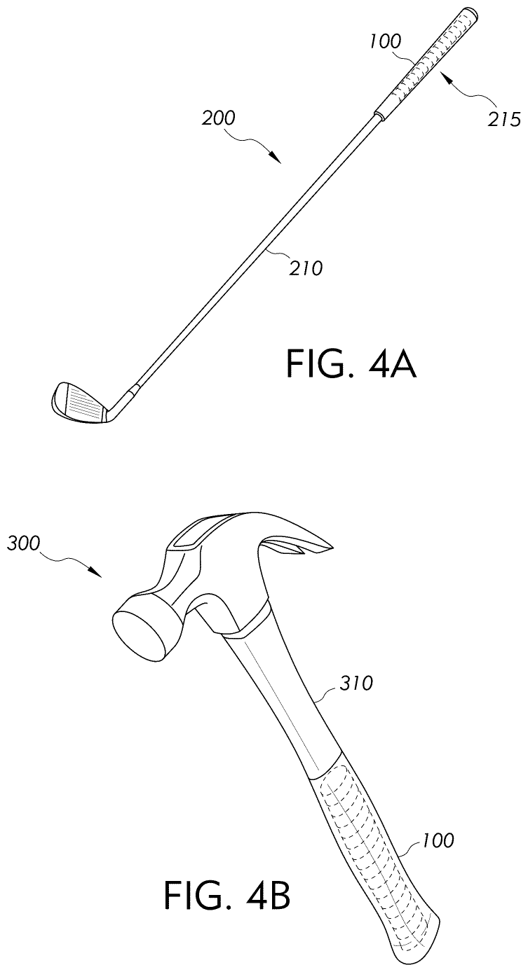

Turning now to FIGS. 4A and 4B, various objects are shown for which coupling to the deformable sensing assemblies described herein, such as the deformable sensing assemblies 100, 400, 500 can provide beneficial information and/or guidance.

More specifically, as shown in FIG. 4A, a golf club 200 includes a shaft 210 with a grip region 215. A user of the golf club 200 is intended to place his or her hands along the grip region 215. Notably, placement and/or strength of a user's grip can impact an outcome of the user's golf swing, for example. Stated another way, an outcome, such as distance and/or exit speed, of hitting a golf ball can be optimized using a particular grip placement and/or strength, for example. As such, the deformable sensing assembly 100 can be coupled to the golf club 200 over top of, or in lieu of, a standard grip, for example. In response to the user placing his or her hands on the impacted regions of the deformable sensing assembly 100, the one or more 3D markers 125 move and/or otherwise disperse within the deformable layer 120. The image sensor 150 can capture one or more images of the impacted region reflected from the mirror 130 during the golf swing. A user and/or a processor can then compare, or otherwise analyze, the captured image against a baseline image captured of the impacted region when no external force is applied thereto. A specific placement of a user's hands and/or the strength with which the user's grip is applied can be deduced from the analysis of the captured image against the baseline image. In various instances, more than one images can be captured and analyzed against the baseline image. As such, a force profile of a user's grip strength and/or placement can be formed over the duration of a golf swing, for example. While FIG. 4A depicts the deformable sensing assembly 100 coupled to the golf club 200, use of the deformable sensing assembly 100 is envisioned for use with various sporting equipment. Exemplary, non-exhaustive, alternative sporting equipment for which the deformable sensing assembly 100 can be coupled thereto includes, for example, a hockey stick, a tennis racket, a badminton paddle, a pickle ball paddle, a baseball bat, firearms, archery equipment, and/or the like.

While FIG. 4A depicts and describes coupling a deformable sensing assembly, such as the deformable sensing assembly 100, to sporting equipment, the deformable sensing assembly can also yield beneficial information and/or guidance when coupled to industrial equipment. In various instances, the same deformable sensing assembly can be removably and selectively coupled to both sporting equipment and industrial equipment. For example, as shown in FIG. 4B, the deformable sensing assembly 100 can be coupled to a shaft 310 of a hammer 300. As with the golf club 200 described above, placement and/or strength of a user's grip can impact an outcome of the user's hammer swing, for example. Stated another way, an outcome of hitting a nail, for example, can be optimized using a particular grip placement and/or strength. As such, the deformable sensing assembly 100 can be coupled to the hammer 300 over top of a shaft 310 thereof. In response to the user placing his or her hands on the impacted regions of the deformable sensing assembly 100, the one or more 3D markers 125 move and/or otherwise disperse within the deformable layer 120. The image sensor 150 can capture an image of the impacted region reflected from the mirror 130. A user and/or a processor can then compare, or otherwise analyze, the captured image against a baseline image captured of the impacted region when no external force is applied thereto. A specific placement of a user's hands and/or the strength with which the user's grip is applied can be deduced from the analysis of the captured image against the baseline image. In various instances, more than one images can be captured and analyzed against the baseline image. As such, a profile of a user's grip strength and/or placement can be formed over the duration of use of the hammer, such as over a work shift, for example.

Coupling the deformable sensing assembly 100 to such industrial equipment can yield information to assist in educating a user how to hold the industrial equipment to be most efficient and/or yield a desired, or optimized result. Information gathered from a presence of the deformable sensing assembly 100 positioned on industrial equipment can also serve to alleviate injuries incurred by a user due to improper handling and/or misuse of the industrial equipment. Exemplary, non-exhaustive, alternative industrial equipment for which the deformable sensing assembly 10 can be coupled thereto includes, for example, a welding gun, a saw, power tools, and/or the like.

The deformable sensing assemblies disclosed herein can be used to perform a method for monitoring an external force applied to an object. The method includes capturing, by an image sensor, a baseline image of a deformable sensing assembly coupled to an object, wherein the deformable sensing assembly includes one or more 3D markers movable in response to an external force applied thereto. The method further includes capturing, by an image sensor, a second image of the deformable sensing assembly upon application of an external force thereto and comparing, by a processor, an orientation of the one or more 3D markers in the baseline image to an orientation of the one or more 3D markers in the second image. The method further includes deducing, by the processor, a location of the applied external force along an impacted region based at least in part on the comparison of the orientation of the one or more 3D markers between the baseline image and the second image and deducing, by the processor, a force profile of the applied external force along the impacted region based at least in part on the comparison of the orientation of the one or more 3D markers between the baseline image and the second image.

It should now be understood that embodiments of the present disclosure are directed deformable sensors capable of detecting contact with an object as well as a force profile of such contact. The information provided by the deformable sensing assembly may then be used to provide feedback to a user, including a particular contact position and/or strength, to optimize a result of using the particular object.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A deformable sensing assembly, comprising:
a hollow vessel comprising a first side and a second side, wherein the first side is positioned opposite the second side;
a deformable layer coupled to at least a portion of the hollow vessel, the deformable layer comprising:
one or more 3D markers suspended in the deformable layer, wherein the one or more 3D markers are movable in response to an external force applied thereto;
an image sensor positioned on the first side of the hollow vessel; and
a mirror positioned on the second side of the hollow vessel, wherein a portion of the deformable layer positioned between the image sensor and the mirror defines an impacted region to which the external force is applied, and wherein the image sensor captures an image representative of the impacted region reflected to the image sensor by the mirror;
wherein a force profile of the external force applied to the impacted region is deduced using the image captured by the image sensor.

2. The deformable sensing assembly of claim 1, wherein the force profile comprises a location of the applied external force along the impacted region.

3. The deformable sensing assembly of claim 1, wherein the force profile comprises a strength of the applied external force along the impacted region.

4. The deformable sensing assembly of claim 1, wherein the hollow vessel is coupled to an object to be monitored.

5. The deformable sensing assembly of claim 4, wherein the object comprises a golf club.

6. The deformable sensing assembly of claim 4, wherein the object comprises a welding gun.

7. The deformable sensing assembly of claim 1, wherein the one or more 3D markers are equidistantly dispersed throughout the deformable layer when an application of the external force is absent.

8. The deformable sensing assembly of claim 1, wherein the one or more 3D markers comprises beads.

9. The deformable sensing assembly of claim 1, wherein the one or more 3D markers comprises glitter.

10. The deformable sensing assembly of claim 1, wherein the deformable layer further comprises a suspension medium to suspend the one or more 3D markers therethrough.

11. The deformable sensing assembly of claim 1, wherein the mirror is a conical mirror.

12. A deformable sensing assembly, comprising:
a deformable layer, comprising:
one or more 3D markers movable in response to an external force applied thereto, wherein the one or more 3D markers are positioned in a region of the deformable layer defining an impacted region; and
an image sensor to capture an image representative of the impacted region;
wherein a force profile of the external force applied to the impacted region is determined using a displacement of the one or more 3D markers in response to the applied external force.

13. The deformable sensing assembly of claim 12, wherein the deformable layer comprises a 3D mesh structure, and wherein the one or more 3D markers are supported on the 3D mesh structure.

14. The deformable sensing assembly of claim 12, wherein the deformable layer comprises a deformable tube wrapped directly around an object to be manipulated by a user.

15. The deformable sensing assembly of claim 12, wherein the deformable layer is slid onto an object to be manipulated by a user.

16. The deformable sensing assembly of claim 12, wherein the one or more 3D markers are suspended within the deformable layer.

17. The deformable sensing assembly of claim 16, wherein the deformable layer comprises a suspension medium to suspend the one or more 3D markers therethrough.

18. The deformable sensing assembly of claim 12, wherein the image sensor captures a baseline image of the impacted region in the absence of the applied external force.

19. The deformable sensing assembly of claim 12, wherein the one or more 3D markers are flexible.

20. A method for monitoring an external force applied to an object using a deformable sensing assembly, the method comprising:
capturing, by an image sensor, a baseline image of a deformable sensing assembly coupled to an object, wherein the deformable sensing assembly includes one or more 3D markers movable in response to an external force applied thereto;
capturing, by an image sensor, a second image of the deformable sensing assembly upon application of an external force thereto;
comparing, by a processor, an orientation of the one or more 3D markers in the baseline image to an orientation of the one or more 3D markers in the second image;
deducing, by the processor, a location of the applied external force along an impacted region based at least in part on the comparison of the orientation of the one or more 3D markers between the baseline image and the second image; and
deducing, by the processor, a force profile of the applied external force along the impacted region based at least in part on the comparison of the orientation of the one or more 3D markers between the baseline image and the second image.
